(19) United States
(12) Patent Application Publication
(10) Pub. No.: US 2026/0001174 A1
(43) Pub. Date: Jan. 1, 2026

(54) TELESCOPING LIFT MECHANSIM WITH AUTOMATIC SELF-LOCKING

(71) Applicant: LensDigital, LLC, Old Bridge, NJ (US)

(72) Inventors: Leonid Karchevsky, Morganville, NJ (US); Eugene Miroshnichenko, Monroe Township, NJ (US); Stanley Altshuller, Morganville, NJ (US)

(73) Assignee: LensDigital, LLC, Old Bridge, NJ (US)

(21) Appl. No.: 19/239,708

(22) Filed: Jun. 16, 2025

Related U.S. Application Data
(60) Provisional application No. 63/666,073, filed on Jun. 28, 2024.

(51) Int. Cl. B23K 37/02; F16H 55/26

(52) U.S. Cl. CPC B23K 37/0223; F16H 55/26

(57) ABSTRACT

The present disclosure provides a lift mechanism comprising a wheel connected to a worm screw, a gearbox housing a worm gear engaged with the worm screw, a pinion gear coupled to the worm gear, and a rack gear with rack teeth engaged with the pinion gear. The lift mechanism includes a guide rail and bearing blocks facilitating linear motion of the rack gear. A rack bracket supports the rack gear, and a worm screw support stabilizes the worm screw. The gearbox contains a gearbox interior housing the mechanical components and a gearbox exterior. Rotation of the wheel translates to linear motion of the rack gear through the interaction of the worm screw, worm gear, and pinion gear, providing a compact, self-locking telescoping mechanism for precise vertical or horizontal adjustment in space-constrained environments.

### CROSS REFERENCE TO RELATED APPLICATION

This application claims priority to U.S. Patent Application Ser. No. 63/666,073, titled ROTARY ATTACHMENT APPARATUS FOR LASER ENGRAVING WITH SELF-CENTERING JAWS AND ADJUSTABLE STOPPERS, filed Jun. 28, 2024, which is hereby incorporated by reference in its entirety.

### FIELD OF THE DISCLOSURE

The invention relates in general to the field of lift mechanism technology, and more particularly, to a telescoping apparatus configured to utilize a rotational input to provide a linear output.

### BACKGROUND

Lifting mechanisms play a crucial role in various industries, enabling the precise positioning and movement of components, tools, and materials. These mechanisms are utilized in a wide range of applications, from construction equipment to manufacturing processes, where accurate vertical or horizontal adjustments are required.

In manufacturing and precision equipment, lifting mechanisms are particularly important for ensuring optimal performance and quality control. They allow for fine-tuning of equipment settings, facilitating the production of high-quality products with consistent specifications. The ability to make precise adjustments is especially valuable in industries that demand exacting standards, such as electronics manufacturing, aerospace, and medical device production.

Laser engraving machines represent a specific application where lifting mechanisms are integral to the overall functionality and performance of the equipment. These mechanisms serve a primary purpose in laser engraving systems: adjusting the focal distance between the laser source and the material being engraved. This adjustment is necessary to accommodate materials of varying thicknesses and to maintain the optimal focus of the laser beam on the workpiece surface.

The role of lifting mechanisms in laser engraving machines extends beyond simple height adjustment. They directly impact the precision and quality of the engraving process. By allowing for minute adjustments in the focal distance, these mechanisms enable operators to achieve the desired engraving depth, line width, and overall detail in their work. Furthermore, the ability to quickly and accurately adjust the lifting mechanism facilitates efficient workflow, allowing for rapid transitions between different material types and thicknesses.

However, current lifting mechanisms used in laser engraving machines face several challenges and limitations. Many existing systems rely on external locking mechanisms to maintain the desired position. These mechanisms may be prone to slipping under load or require frequent adjustments, potentially compromising the accuracy and consistency of the engraving process. Moreover, if an external locking mechanism fails or is not properly engaged, there is a risk of the laser head or workpiece falling, potentially causing damage to the equipment, the material being engraved, or even posing safety hazards to operators.

Another limitation of many current lifting mechanisms is their tendency to protrude significantly, even when in a retracted state. This protrusion can interfere with other components of the laser engraving machine or limit the available workspace. In some cases, it may also restrict the size or shape of materials that can be accommodated in the engraving area. Prior art systems typically required a fixed length rail on which the object mount slides using rollers, leadscrews, bearings, or similar components. For example, if a vertical adjustment of 100 mm is needed, the system would require a rail of at least 100 mm in length, plus additional space for mounting hardware. Furthermore, to maintain a specific position along this travel distance, these systems require some kind of clamping mechanism, which adds complexity, weight, and potential points of failure. These design constraints can limit the versatility and efficiency of laser engraving machines, potentially impacting productivity and the range of applications for which the equipment can be used. Therefore, there is an unmet need to provide for a lift mechanism capable of automatic self-locking and collapsing into a compact design when retracted.

These and other objects, features, and advantages of the present invention will become more readily apparent from the attached drawings and the detailed description of the preferred embodiments, which follow.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Bearing in mind the problems and deficiencies of the prior art, it is therefore an object of the present invention to provide a telescoping lift mechanism comprising:

According to an aspect of the present disclosure, a laser engraving apparatus is provided. The laser engraving apparatus includes a laser etching device configured to laser etch an object. The laser engraving apparatus also includes a lift mechanism configured to provide a telescoping lift to the laser etching device. The lift mechanism includes a wheel configured to receive a rotational input causing the wheel to rotate about a first axis. The lift mechanism also includes a worm screw comprising a worm shaft coupled to a wheel shaft of the wheel, wherein the worm screw rotates about the first axis with the wheel. The lift mechanism further includes a worm gear configured to mesh with the worm screw, the worm gear comprising a pinion slot, and wherein the worm gear is configured to rotate about a second axis. The lift mechanism also includes a pinion gear comprising a pinion shaft configured to insert into the pinion slot, wherein the pinion gear rotates with the worm gear about the second axis in a first direction and a second direction. The lift mechanism further includes a fixed rack gear and a moveable rack gear configured to mesh with the pinion gear, wherein the fixed rack gear and the moveable rack gear move between an extended state and a retracted state.

According to other aspects of the present disclosure, the laser engraving apparatus may include one or more of the following features. The fixed rack gear may be statically coupled to a mounting surface of the laser engraving apparatus, and the moveable rack gear may be coupled to the laser etching device. A gear reduction ratio between the worm screw and the worm gear may be sufficiently high to prevent movement of the pinion gear without the rotational input of the wheel. The gear reduction ratio may be between 10:1 and 50:1. The lift mechanism may further include a gearbox housing the worm screw and the worm gear. The lift mechanism may further include a first bearing block coupled to a gearbox exterior, the first bearing block configured to guide the fixed rack gear along a first linear path relative to the gearbox, and a second bearing block coupled to the gearbox exterior, the second bearing block configured to guide the moveable rack gear along a second path relative to the gearbox. The worm screw may further include a helix configured to mesh with a set of worm gear teeth of the worm gear. The helix may include a helix angle providing for a gear reduction ratio sufficient to prevent a load force being applied to the worm screw through the worm gear from causing the worm screw to rotate. The lift mechanism may further include a motor configured to engage the wheel, and a processor configured to receive an input, wherein the processor engages the motor to rotate the wheel based on the received input. The lift mechanism may further include a sensor configured to measure change in distance of the load.

According to another aspect of the present disclosure, a lift mechanism for adjusting the height of a laser etcher of a laser engraving apparatus is provided. The lift mechanism includes a wheel configured to receive a rotational input causing the wheel to rotate about a first axis. The lift mechanism also includes a worm screw having a worm shaft coupled to a wheel shaft of the wheel, wherein the worm screw rotates about the first axis with the wheel. The lift mechanism further includes a worm gear configured to mesh with the worm screw, the worm gear comprising a pinion slot, and wherein the worm gear is configured to rotate about a second axis. The lift mechanism also includes a pinion gear comprising a pinion shaft configured to insert into the pinion slot, wherein the pinion gear rotates with the worm gear about the second axis in a first direction and a second direction. The lift mechanism further includes a fixed rack gear and a moveable rack gear configured to mesh with the pinion gear, wherein the fixed rack gear and the moveable rack gear move between an extended state and a retracted state.

According to other aspects of the present disclosure, the lift mechanism may include one or more of the following features. The fixed rack gear may be statically coupled to a mounting surface of the laser engraving apparatus, and the movable rack gear may be coupled to a laser etching device. A gear reduction ratio between the worm screw and the worm gear may be sufficiently high to prevent movement of the pinion gear without the rotational input of the wheel. The lift mechanism may further include a motor configured to engage the wheel, and a processor configured to receive an input, wherein the processor engages the motor to rotate the wheel based on the received input.

According to aspects of the present disclosure, a laser engraving apparatus with a lift mechanism system is provided for. The lift mechanism system may include a first lift mechanism mounted to a first portion of the laser engraving apparatus and a second lift mechanism mounted to a second portion of the laser engraving apparatus. Each the first lift mechanism and the second lift mechanism may include a wheel configured to receive a rotational input causing the wheel to rotate about a first axis; a worm screw having a worm shaft coupled to a wheel shaft of the wheel, wherein the worm screw rotates about the first axis with the wheel; a worm gear configured to mesh with the worm screw, the worm gear comprising a pinion slot, and wherein the worm gear is configured to rotate about a second axis; a pinion gear comprising a pinion shaft configured to insert into the pinion slot, wherein the pinion gear rotates with the worm gear about the second axis in a first direction and a second direction; a fixed rack gear and a moveable rack gear configured to mesh with the pinion gear, wherein the fixed rack gear and the moveable rack gear move between an extended state and a retracted state, wherein the fixed rack gear is coupled to a mounting surface of the laser engraving apparatus, wherein the moveable rack gear of the first lift mechanism is coupled to a first end of the object, and wherein the moveable rack gear of the second lift mechanism is coupled to a second end of the object.

According to other aspects of the present disclosure, the laser engraving apparatus may include one or more of the following features. The laser engraving apparatus further may include a horizontal rail. The first lift mechanism may be slidably coupled to the horizontal rail. Each of the first lift mechanism and the second lift mechanism may be slidably coupled to the horizontal rail. The first lift mechanism and the second lift mechanism are configured to be adjusted simultaneously. The lift mechanism system may further include a third lift mechanism coupled to a laser etching device, the laser etching device configured to engrave the object.

According to another aspect of the present disclosure, a method of operating a lift mechanism for a laser engraving apparatus is provided. The method includes receiving a rotational input at a wheel. The method also includes rotating a worm screw coupled to the wheel about a first axis. The method further includes rotating a worm gear meshing with the worm screw about a second axis. The method also includes rotating a pinion gear coupled to the worm gear about the second axis. The method further includes moving a movable rack gear linearly relative to a fixed rack gear, the movable rack gear and fixed rack gear meshing with the pinion gear, wherein the linear movement of the movable rack gear adjusts a position of a laser etching device.

According to other aspects of the present disclosure, the method may include one or more of the following features. The method may further include guiding the fixed rack gear along a first linear path relative to a gearbox housing the worm screw and the worm gear, and guiding the movable rack gear along a second linear path relative to the gearbox. Guiding the fixed rack gear and the movable rack gear may include using a first bearing block coupled to an exterior of the gearbox to guide the fixed rack gear, and using a second bearing block coupled to the exterior of the gearbox to guide the movable rack gear. A gear reduction ratio between the worm screw and the worm gear may be sufficiently high to prevent movement of the pinion gear without the rotational input of the wheel. The gear reduction ratio may be between 10:1 and 50:1. The method may further include receiving an input at a processor, engaging a motor coupled to the wheel based on the received input, and rotating the wheel using the motor to adjust the position of the laser etching device.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1A illustrates a top, right-side isometric front view of an exemplary embodiment of the telescoping lift mechanism in accordance with one or more embodiments of the present disclosure;

FIG. 1B illustrates a top, left-side isometric front view of an exemplary embodiment of the telescoping lift mechanism in accordance with one or more embodiments of the present disclosure;

FIG. 1C illustrates a rear view of an exemplary embodiment of the telescoping lift mechanism in accordance with one or more embodiments of the present disclosure;

FIG. 2 illustrates a top, left-side isometric front view of an exemplary embodiment of the telescoping lift mechanism without the gearbox in accordance with one or more embodiments of the present disclosure;

FIG. 3 illustrates an exploded top, right-side isometric front view of an exemplary embodiment of the telescoping lift mechanism in accordance with one or more embodiments of the present disclosure;

FIG. 4 illustrates an exploded top, left-side isometric rear view of an exemplary embodiment of the telescoping lift mechanism in accordance with one or more embodiments of the present disclosure;

FIG. 5 illustrates a laser engraving apparatus utilizing a lift mechanism in accordance with one or more embodiments of the present disclosure;

FIG. 6 illustrates an exemplary method in accordance with one or more embodiments of the present disclosure;

FIG. 7 is a perspective view from the left side of the alternate embodiment of the apparatus looking from the motor of the apparatus;

FIG. 8 is a perspective view from the right side of the alternate embodiment of the apparatus looking from the motor of the apparatus;

FIG. 9 is a close-up perspective view from the left side of the alternate embodiment of the apparatus looking from the motor of the apparatus;

FIG. 10 is a close-up perspective view of the back support adjustment mechanism from the left side of the alternate embodiment of the apparatus;

FIG. 11 is a top perspective exploded view from the left side of the chuck assembly;

FIG. 12 is a top perspective exploded view from the right side of the chuck assembly;

FIG. 13 shows a view of the chuck assembly vertical lift adjustment mechanism;

FIG. 14 shows a bottom view of the chuck assembly;

FIG. 15 shows a front view of the chuck assembly; and

FIG. 16 shows a sectional view of the chuck assembly.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The examples described are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Within the disclosure the term motor can mean any rotary motion device such as an electric motor, servo motor, DC motor, AC motor, stepping motor, pneumatic motor or hydraulic motor.

As this invention is susceptible to embodiments of many different forms, it is intended that the present disclosure be considered as an example of the principles of the invention and not intended to limit the invention to the specific embodiments shown and described.

The present disclosure relates to a telescoping lift mechanism 100 with automatic self-locking and a collapsed retractable state. This mechanism may be utilized in various applications where precise vertical or horizontal adjustment is required, while maintaining a compact profile when not in use. The lift mechanism incorporates a gear system that provides controlled motion and automatic locking when stationary, eliminating the need for separate locking mechanisms.

In some cases, the lift mechanism may have a compact profile when in a neutral, collapsed position. This feature allows the mechanism to be integrated into space-constrained environments without interfering with surrounding components or operations. The compact design may be achieved through the alignment of internal components when the mechanism is fully retracted.

The lift mechanism may incorporate a combination of gears and linear motion components to achieve its functionality. This arrangement may allow for smooth extension and retraction while maintaining stability and precision throughout its range of motion. The self-locking feature may provide secure positioning without additional locks or clamps.

In some implementations, the lift mechanism may be operated manually or through motorized means, offering flexibility in various applications. The mechanism's design may allow for easy integration with existing systems or as a standalone unit for lifting, positioning, or support functions.

The present disclosure relates to a telescoping lift mechanism 100 capable of lifting a load by converting a rotational input into a linear output and automatic self-locking. This mechanism may be utilized in various applications where precise vertical or horizontal positioning is required, particularly in space-constrained environments. The lift mechanism incorporates a compact design that minimizes protrusion when in a retracted position, allowing for efficient operation in tight spaces.

The mechanism may employ a combination of gears, including a worm gear system, to provide smooth and controlled movement. This gear arrangement may also contribute to the self-locking feature of the mechanism, potentially eliminating the need for separate locking devices or clamps. The self-locking capability may help maintain the mechanism's position even under load, which may be beneficial in applications where stability is crucial.

In some cases, the lift mechanism may include a telescoping rack gear system that enables extension and retraction while maintaining a compact profile when not in use. This telescoping feature may allow for a significant range of motion without requiring a large footprint in its neutral position.

The mechanism may be designed for versatility in operation, potentially allowing for both manual and motorized control. This flexibility may make the mechanism suitable for a wide range of applications and user preferences.

Overall, the telescoping lift mechanism 100 with automatic self-locking may offer a solution for precise positioning in applications where space efficiency, stability, and ease of use are desired characteristics.

Throughout the present disclosure, reference will be made to lifting a load or a lift mechanism/apparatus, but it should be understood the term lift or lifting refers to the linear movement of the load and not necessarily moving the load in a conventionally upward direction. That is, the lift or linear output may be in any of the vertical direction, horizontal direction, or any direction therebetween depending on the orientation of the apparatus. The lift mechanism 100 may include a wheel 102 which, when rotational movement in a first direction is applied thereto, at least one guiderail 128 is configured to extend linearly from the lift mechanism 100. Rotating the wheel 102 in a second direction may cause the guiderail 128 to retract. As the guiderail 128 is extended or retracted linearly from the lift mechanism 100, a load may be carried with the guiderail 128. The lift mechanism 100 may be capable of self-locking while no rotational force is applied to the wheel 102. While no rotational movement is applied to the wheel 102, internal gears of the lift mechanism 100 automatically lock in place, preventing the guiderail(s) 128 and their load from experiencing linear motion. It should be noted that the retracted position allows for a more compact design, ensuring the lift mechanism 100 does not interfere with surrounding mechanisms or is easier to transport.

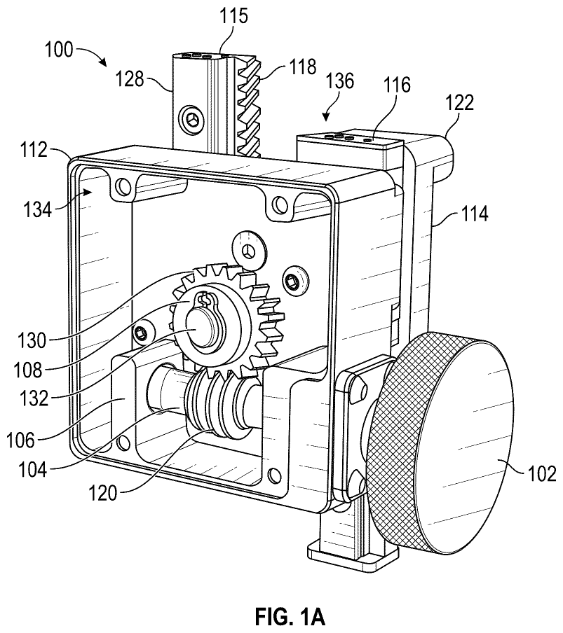

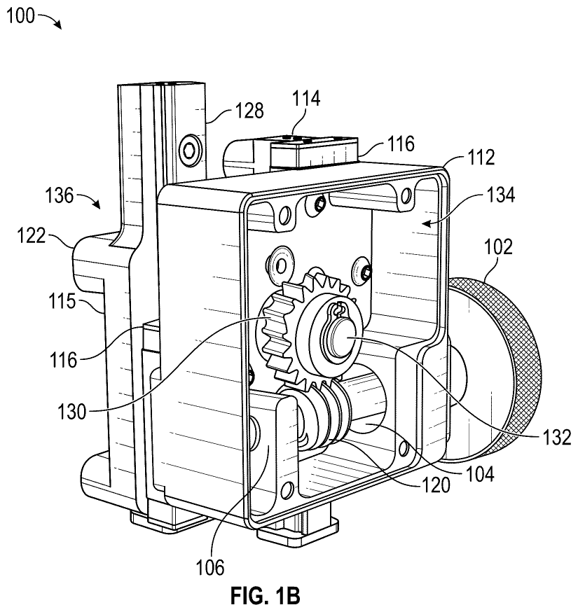

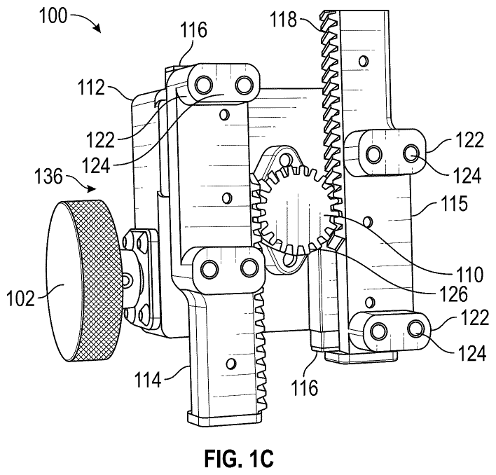

The lift mechanism 100 may include a wheel 102 and a worm screw 104 assembly that initiates the lifting action. In some cases, the wheel 102 may be directly connected to the worm screw 104, as shown in FIG. 1A and FIG. 1B. The worm screw 104 may be supported by a worm screw support 106, which helps maintain proper alignment and stability during operation.

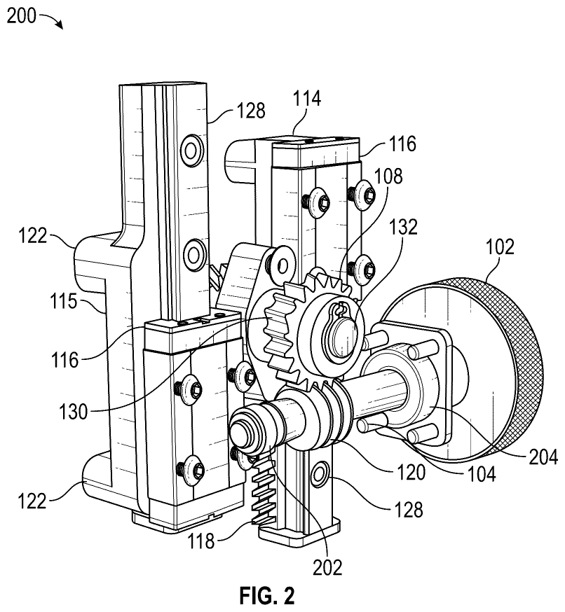

The worm screw 104 may include worm screw teeth 120 along its length, as illustrated in FIG. 1A, FIG. 1B, and FIG. 2. These worm screw teeth 120 may engage with other components of the lift mechanism 100 to convert rotational motion into linear motion. In some implementations, the worm screw 104 may be supported by a worm screw bearing 202, which may help reduce friction and ensure smooth rotation of the worm screw 104.

The wheel 102 may be designed for manual operation, allowing a user to turn the wheel 102 by hand to activate the lift mechanism 100. In some cases, the wheel 102 may include ergonomic features such as a textured or grooved surface to improve grip and ease of use. The wheel 102 may be supported by a wheel bearing 204, as shown in FIG. 2, which may help facilitate smooth rotation and reduce wear over time.

In some implementations, the lift mechanism 100 may be operated automatically using a motor instead of manual operation. The motor may be connected to the worm screw 104 either directly or through a coupling mechanism, replacing or supplementing the wheel 102. This configuration may allow for precise control and automated operation of the lift mechanism 100 in applications where manual operation may not be practical or desired.

The design of the wheel 102 and worm screw 104 assembly may take into account factors such as mechanical advantage, self-locking capabilities, and overall compactness of the lift mechanism 100. The pitch and diameter of the worm screw 104 may be selected to provide an appropriate balance between lifting force and speed of operation. Additionally, the materials used for the wheel 102, worm screw 104, and associated components may be chosen to ensure durability and resistance to wear under repeated use.

The lift mechanism 100 may include a worm gear 108 and pinion gear 110 assembly that works in conjunction with the worm screw 104 to translate rotational motion into linear motion. As shown in FIG. 1A and FIG. 1B, the worm gear 108 may be housed within the gearbox 112 and may engage with the worm screw teeth 120 of the worm screw 104.

The worm gear 108 may include worm gear teeth 130 that mesh with the worm screw teeth 120. This engagement allows the rotational motion of the worm screw 104 to be transferred to the worm gear 108. In some cases, the worm gear 108 may be mounted on a pinion gear shaft 132, as illustrated in FIG. 1A and FIG. 2.

A pinion gear 110 may be connected to the worm gear 108 via the pinion gear shaft 132. The pinion gear 110 may include pinion gear teeth 126, as shown in FIG. 1C. These pinion gear teeth 126 may engage with the rack teeth 118 of the first rack gear 114 and the second rack gear 115, converting the rotational motion of the worm gear 108 into linear motion of the first and second rack gears 114, 115.

The gear ratio between the worm screw 104 and the worm gear 108 may vary depending on the specific application requirements. In some cases, the gear ratio may range from 5:1 to 100:1. For example, a gear ratio of 20:1 may provide an ideal balance between mechanical advantage and speed of operation for many applications. With a 20:1 ratio, 20 complete rotations of the worm screw 104 may result in one complete rotation of the worm gear 108.

The helix angle of the worm screw teeth 120 may play a crucial role in the operation of the lift mechanism 100. The angle may be designed to allow the worm screw 104 to drive the worm gear 108 when rotational force is applied to the wheel 102 or the worm screw 104. However, the same angle may prevent the worm gear 108 from driving the worm screw 104 in the opposite direction. This feature may contribute to the self-locking capability of the lift mechanism 100, helping to maintain its position when no rotational input is applied.

In some implementations, a lower gear ratio, such as 5:1, may provide faster operation but may require more input force. Conversely, a higher gear ratio, such as 100:1, may offer greater mechanical advantage but may result in slower operation. The selection of an appropriate gear ratio may depend on factors such as the expected load, desired speed of operation, and the specific application requirements.

The worm gear 108 and pinion gear 110 assembly may be designed to operate efficiently within the compact space of the gearbox 112. The materials used for these components may be selected to minimize friction and wear, potentially enhancing the longevity and reliability of the lift mechanism 100.

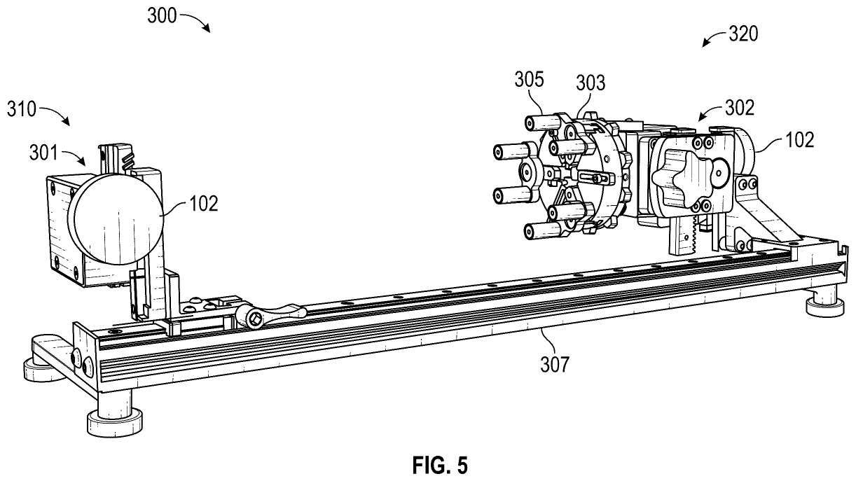

The lift mechanism 100 may include a rack gear system including a first rack gear 114, a second rack gear 115, and guide rail 128 that facilitates linear motion and provides stability during operation. The first rack 114 may be mounted to a laser engraving apparatus 300 or another base. In some embodiments, the second rack gear 115 may be mounted to an object to be engraved or some other load. In other embodiments, the second rack gear 115 may be mounted to a gripping device such as the chuck housing 303 shown in FIG. 5.

In some cases, the first and second rack gears 114, 115 may include rack teeth 118, as shown in FIG. 1A, FIG. 1C, and FIG. 2. These rack teeth 118 may engage with the pinion gear teeth 126 of the pinion gear 110, allowing for the conversion of rotational motion into linear motion. Each rack gear 114, 115 may be supported by a rack bracket 122, which may help maintain proper alignment and stability during operation.

The lift mechanism 100 may incorporate a guide rail 128 system that works in conjunction with the rack gears 114, 115. As illustrated in FIG. 1A and FIG. 1B, the guide rail 128 may provide a track along which the first and second rack gears 114, 115 can move. This arrangement may help ensure smooth and precise linear motion while maintaining the stability of the system.

To facilitate smooth movement along the guide rail 128, the lift mechanism 100 may utilize a bearing block 116. As shown in FIG. 1A, FIG. 1B, and FIG. 1C, the bearing blocks 116 may be attached to the first and second rack gears 114, 115 or rack bracket 122. The bearing blocks 116 may include internal components such as ball bearings or linear bushings that allow for low-friction movement along the guide rail 128.

In some implementations, the lift mechanism 100 may incorporate a fixed rack gear and a movable rack gear that slide along linear guide rails. This configuration may allow for a telescoping action, enabling the lift mechanism 100 to extend and retract while maintaining stability. The fixed rack gear may be securely attached to the gearbox 112 or another stationary part of the mechanism, while the movable rack gear may be free to slide along the guide rails.

The lift mechanism 100 may use linear bearing blocks for smooth sliding of the free rack gear. These linear bearing blocks may be similar to or the same as the bearing block 116 mentioned earlier. By utilizing linear bearing blocks, the lift mechanism 100 may achieve precise and low-friction movement of the movable rack gear along the guide rails.

In some cases, the first and second rack gears 114, 115 and guide rail 128 of the rack gear system may be designed to allow for a compact, retracted state. When fully retracted, the first and second rack gears 114, 115 may align closely with other components of the lift mechanism 100, creating a non-protruding, low profile. This feature may be particularly beneficial in applications where space is limited or where a compact form factor is desired when the lift mechanism 100 is not in use.

The first and second rack gears 114, 115 may include one or more mounting points 124, as shown in FIG. 1C. These mounting points 124 may allow for the attachment of various loads or accessories to the lift mechanism 100, depending on the specific application requirements.

Different configurations of the rack gear system may be implemented to suit various applications. For example, in some cases, multiple rack gears may be used in parallel to increase load capacity or stability. In other implementations, the orientation of the guide rails may be adjusted to allow horizontal or angled linear motion, rather than purely vertical movement.

The materials used for the first and second rack gears 114, 115, guide rail 128, and associated components may be selected based on factors such as load capacity, environmental conditions, and desired longevity. For instance, in applications requiring high precision or resistance to corrosion, stainless steel or other corrosion-resistant alloys may be used for these components.

The lift mechanism 100 may include a gearbox 112 that houses and protects the internal components of the mechanism. As shown in FIG. 1A and FIG. 1B, the gearbox 112 may comprise a gearbox interior 134 and a gearbox exterior 136. The gearbox interior 134 may contain various mechanical components such as the worm gear 108, pinion gear 110, and pinion gear shaft 132, while the gearbox exterior 136 may provide a protective enclosure for these components.

In some cases, the gearbox 112 may be designed to be compact, allowing the lift mechanism 100 to maintain a small footprint when in use or in a retracted position. The compact design of the gearbox 112 may contribute to the overall space efficiency of the lift mechanism 100, potentially making the mechanism suitable for use in confined spaces or applications where minimizing size is a consideration.

The gearbox exterior 136 may be constructed from materials selected for their durability and resistance to environmental factors. In some implementations, the gearbox exterior 136 may be made from metals such as aluminum or steel, or from high-strength plastics or composite materials. The choice of material may depend on factors such as the expected operating conditions, load requirements, and weight considerations of the specific application.

The gearbox interior 134 may be designed to provide proper alignment and support for the internal components. As illustrated in FIG. 1B, the gearbox interior 134 may include mounting points or supports for components such as the worm gear 108 and pinion gear shaft 132. These internal structures may help maintain the precise positioning of the gears, which may be crucial for the smooth and efficient operation of the lift mechanism 100.

In some cases, the gearbox 112 may incorporate features to facilitate maintenance and assembly. For example, the gearbox exterior 136 may include removable panels or access points that allow for inspection or replacement of internal components without requiring complete disassembly of the lift mechanism 100.

The gearbox 112 may also play a role in the overall structural integrity of the lift mechanism 100. As shown in FIG. 1C, the gearbox 112 may serve as a mounting point for other components of the mechanism, such as the rack bracket 122 or the guide rail 128. This integration may help distribute loads and stresses throughout the mechanism, potentially enhancing its stability and durability.

In some implementations, the gearbox 112 may incorporate features for heat dissipation. The operation of the internal gears and bearings may generate heat, particularly under heavy loads or continuous use. The design of the gearbox exterior 136 may include elements such as fins or vents to help dissipate this heat and maintain optimal operating temperatures for the internal components.

The interface between the gearbox 112 and other components of the lift mechanism 100 may be designed for smooth integration. For example, as illustrated in FIG. 2, the gearbox 112 may provide a seamless transition for the worm screw 104 to engage with the worm gear 108 inside the gearbox interior 134. Similarly, the gearbox 112 may be designed to allow for proper alignment of the pinion gear 110 with the first and second rack gears 114, 115, ensuring efficient transfer of motion from the internal gear train to the linear motion of the rack gear 114.

In some cases, the gearbox 112 may be sealed to protect the internal components from dust, moisture, or other contaminants. This sealing may help extend the lifespan of the internal components and maintain the performance of the lift mechanism 100 over time. The sealing method may vary depending on the specific application requirements, potentially ranging from simple gaskets to more advanced sealing technologies for harsh environments.

The design of the gearbox 112 may also take into account the need for lubrication of the internal components. The gearbox interior 134 may be configured to retain lubricants, helping to reduce friction and wear on components such as the worm gear 108, pinion gear 110, and associated bearings. In some implementations, the gearbox 112 may include features for easy replenishment or replacement of lubricants as part of routine maintenance procedures.

FIGS. 1A-1C illustrate an exemplary embodiment of a lift mechanism 100 in accordance with the present disclosure. The lift mechanism 100 may include a wheel 102 capable of receiving rotational input. In one or more embodiments, said wheel 102 may be a handwheel capable of being manually rotated by a user. In other embodiments, the wheel 102 may be connected to a motor capable of providing rotational movement to the wheel. Furthermore, it should be noted the wheel 102 may be replaced with any other mechanism suitable for receiving a rotational force. For example, the wheel 102 may be any of a crank, a lever, a dial, a knob, or any other apparatus suitable for receiving rotational motion. In an embodiment, the wheel 102 may be statically coupled to the first end of a worm screw 104 so that both the worm screw 104 and wheel 102 rotate together about axis A. The worm screw 104 may have a second end dynamically coupled to a worm screw support 106 of the gearbox 112. The worm screw support 106 may include a worm screw bearing 202 (as shown in FIG. 2) to allow the worm screw 104 to freely rotate within the worm screw support 106. In one or more embodiments, the worm screw 104 may have worm screw teeth 120 in the form of a helix configured to mesh with the worm gear teeth 130 of a worm gear 108. In some embodiments, as the worm screw 104 rotates and the worm screw teeth 120 meshes with the worm gear teeth 130, the worm gear 108 may rotate about axis B.

In one or more embodiments, a pinion gear shaft 132 may run through a pinion slot of the worm gear 108 so that the pinion gear 110 rotates about axis B with the worm gear 108. In some embodiments, the pinion gear shaft 132 may extend to an exterior of the gear box 112 so that the pinion gear 110 may be disposed exterior to the gear box 112. In other embodiments, the pinion gear 110 may be disposed within the gearbox's interior.

As shown, only one pinion gear 110 is extending from one side of the worm gear 108, however, the lift mechanism 100 may have a second pinion gear disposed on a pinion gear shaft extending to the other side of the gearbox with its own set of rack gears. The second set of rack gears may be oriented in the same or different direction as the first set of rack gears.

In some embodiments of the present disclosure, the lift apparatus may include a rack and pinion mechanism as shown in FIG. 1C where the pinion gear 110 may have pinion gear teeth 126 configured to mesh with rack teeth 118 of the first and second rack gears 114, 115. In such an embodiment, each the first and second rack gears 114, 115 may have a guiderail 128 configured to use linear motion facilitated by the interaction between said guiderail 128 and a bearing block 116. The bearing block 116 may use recirculating rolling elements, such as balls or rollers, to achieve smooth and precise movement with minimal friction. In some embodiments, the bearing block 116 may be mounted to the gearbox exterior 136. In other embodiments, the bearing block 116 may be disposed within the gearbox interior 134. In one or more embodiments, the pinion gear 110 is configured to convert the rotational motion of the pinion gear into linear motion of the first and second rack gears 114, 115. As the pinion gear 110 rotates in a first direction (e.g., clockwise), the first and second rack gears 114, 115 may be driven outwardly away from the pinion gear 110, entering an extended position. As the pinion gear 110 rotates in a second direction (e.g., counterclockwise), the first and second rack gears 114, 115 may be driven inwardly toward from the pinion gear 110, entering a retracted position. This configuration may allow for synchronized linear motion of the first and second rack gears 114, 115, making it useful in applications where balanced and simultaneous extension and retraction are required, such as in certain types of machinery or automation systems. In such an embodiment and from the perspective of the gear train, the first rack gear 114 may move a first distance in a first direction, and the second rack gear may move a second distance in a second direction where the first distance and second distance or equal. In the same embodiment but from the perspective of the base the first rack gear 114 is fixed or mounted to, as the rack gear system enters the extended state, the gear box may extend a first distance in a first direction while the second rack gear 115 moves a second distance in the same first direction where the second distance is twice the first distance. This may cause the object or other load to move a distance equal to the second distance with respect to the laser engraving apparatus 300.

In other embodiments, there may be a plurality of pinion gears 110 sharing the pinion gear shaft 132. Each pinion gear 110 may have a different gear ratio so that a first pinion gear may have a first gear ratio and a second pinion gear may have a second gear ratio. Such variations in gear ratios may be accomplished by varying the number of teeth of each pinion gear. In such an embodiment, each pinion gear 110 may be configured to mesh with either the first rack gear 114 or the second rack gear 115. As each pinion gear 110 rotates together, their respective rack gears may extend or retract. Due to the varying gear ratios of the pinion gears 110, the rack gear associated with the first pinion gear may extend or retract a first amount for every rotation of the pinion gear while the rack gear associated with the second pinion gear may extend or retract a second amount for every rotation of the pinion gears.

In still other embodiments of the present disclosure, the lift mechanism 100 may have a single pinion gear 110 configured to mesh with a secondary gear configured to rotate about an axis parallel to axis B but in an opposite direction to the rotation of the pinion gear. The pinion gear 110 may also mesh with a first rack gear while the secondary gear may be configured to mesh with a second rack gear. In such an embodiment, both the first and second rack gears 114, 115 may extend and retract is the same direction. The primary pinion gear and the secondary pinion gear may have the same gear ratios causing the first and second rack gears 114 to extend and retract the same distance. On the other hand, the primary pinion gear and the secondary pinion gear may have different gear ratios causing the first rack gear 114 to extend and retract at a different rate than the second rack gear 115.

In one or more embodiments of the present disclosure, the first and second rack gears 114, 115 may include one or more rack brackets 122 having one or more bore holes configured to act as mounting points 124 for a load. The mounting points 124 may use bolts, screws, or other fastening methods suitable for ensuring a stable connection between the first and second rack gears 114, 115 and the load and/or base. As the first and second rack gears 114, 115 transition between the extended and retracted positions, the linear movement may be directly translated to the movement of the load. When the first and second rack gears 114, 115 extend, the load may move in a first direction such as up or outward. When the first and second rack gears 114, 115 retract, the load may move in a second direction such as down or inward.

In some embodiments, the gearbox 112 may be mounted to a mounting surface and the first and second rack gears 114, 115 may each carry a load. In such a configuration, the two loads may move in opposing directions. In other embodiments, the first rack gear 114 may be fixed to the mounting surface while the second rack gear 115 is a moveable rack gear mounted to a load. In such an embodiment, the first rack gear 114 may remain stationary relative to the mounting surface while the gearbox 112 and second rack gear 115 may extend away from or retract toward the first rack gear 114. In some embodiments, the mounting surface may be a wall or other stationary surface suitable for supporting the lift mechanism and the load. In other embodiments, the mounting surface may be the end of a robotic arm or other moveable mechanism designed to support the lift mechanism and the load.

The lift mechanism 100, in one or more embodiments of the present disclosure, may have a self-locking feature so that the worm screw 104, and by extension the load, do not experience movement while no rotation is applied to the wheel 102 despite a heavy load mounted to the rack gear 114. The helix angle of the worm screw 104 allows for a relatively high gear reduction ratio offering high torque to slow speed applications. As a load is carried by the second, moveable rack gear 115, a load force may be applied to the worm gear 108 through the pinion gear 110. This load force may then be applied by the worm gear 108 to the worm screw 104. The worm screw teeth 120, having a sufficiently low helix angle, prevents the worm screw 104 from rotating from the load force from the worm gear 108 when there is no input rotation applied to the worm screw 104. The angle of the worm screw teeth 120 creates a wedging action between the worm gear teeth 130 and the worm screw 104 that prevents the worm gear 108 from moving in reverse while under load. That is, when no rotational force is applied to the wheel 102, the worm screw 104 remains stationary in a self-locking state, and the gear train 200 of the lift mechanism 100 is effectively locked. The load carried by the rack gear 114 cannot cause the worm screw 104 to rotate backward, ensuring that the load remains in place without any additional braking mechanism. Various helix angles and lead angles may be used depending on the materials used for each of the gears as long as they provide a gear reduction ratio sufficient to prevent a load force being applied to the worm screw through the worm gear from causing the worm screw to rotate.

In some embodiments, the lift mechanism 100 may utilize various gear ratios throughout the gear train 200. Such gear ratios may be modified by adjusting any of the radius of the wheel, the pitch or lead angle of the worm screw teeth 120, or the number of teeth on any of the worm gear 108, pinion gear 110, or any other optional intermediate gears throughout the gear train 200. Further, the lift mechanism may include intermediate gear(s) or a wheel bearing 204 between the wheel and worm screw to adjust the gear ratio therebetween. Any gear ratio may be used, but a relatively smaller gear ratio, such as, for example, 10:1 or 100:1, may be desirable. Such a small gear ratio may allow a user to manually turn the wheel using relatively little force to move a heavy load that would otherwise be impossible for the user to lift on their own. For example, with a 100:1 gear ratio, a user may apply 10 pounds of torque to the wheel 102 in order to lift a 1000-pound load. Another advantage of using a small gear ratio would be to allow for more accurate micro adjustments. For example, the application using the lift mechanism 100 may require the load to be moved to a specific distance to the nearest hundredth of a millimeter. A smaller gear ratio would allow for relatively large rotations of the wheel to result in relatively small adjustments in position of the load. In such a configuration, load positioning may have significantly increased accuracy.

In an embodiment, the lift mechanism 100 may provide for measuring the vertical and/or horizontal distance the load is extended by. The lift mechanism 100 may position the load anywhere between the fully extended position and the fully retracted position. In some embodiments, the lift mechanism 100 may utilize a ruler (not pictured) disposed upon the mounting surface, wherein said ruler may allow for the lift height of the lift mechanism 100 to be ascertained. The ruler may be engraved and/or painted onto the mounted surface. In other embodiments, the lift mechanism 100 may utilize a distance or proximity sensor capable of measuring a distance between the load and a reference point. In still other embodiments, the lift mechanism 100 may include a rotary encoder configured to measure the rotations of any of the gears of the gear train 200. The rotary encoder may be an incremental encoder or, preferably, an absolute encoder. A measurement of the number of rotations of any of the gears of the gear train 200 may then be converted to a distance the load has been extended or retracted. In further or alternate embodiments, the distance sensor and/or rotary encoder may be capable of measuring a change in distance of the load relative to a total range of motion. For example, the lift mechanism may have a finite range of motion, such as ten (10) centimeters, fifty (50) centimeters, or one-hundred (100) centimeters, and the distance sensor and/or rotary encoder may be capable of determining where within the range of motion the load resides. That is, in an embodiment where the lift mechanism has a total range of motion of fifty (50) centimeters, the distance sensor and/or rotary encoder may recognize that, while in the fully retracted state, the load is at zero (0) centimeters and that, while in the fully extended state, the load is at fifty (50) centimeters. Further, the distance sensor and/or rotary encoder may be able to measure intermediate positions between the fully retracted state and the fully extended state such as ten (10), twenty-five (25), and forty (40) centimeters. It should be noted that centimeters are only meant to be a nonlimiting example and other units of measurement are contemplated as well. For example, the distance may be measured in millimeters, meters, inches, feet, or any other unit of measurement which may be suitable for the task being completed.

In some embodiments, the distance sensor and/or the rotary encoder may be in communication with a computer configured to display the measured distance to a user manually adjusting the height of the lift mechanism 100. The computer may be configured to automatically determine the optimal height of the lift mechanism 100 based on the diameter and/or taper of an engraving object being processed. In another embodiment, the user may enter a desired height of the lift mechanism 100 or select from predefined presets corresponding to specific objects such as 20 oz tumblers, 40 oz tumblers, water bottles, wine glasses, or other commonly engraved items. These presets may store optimal height settings that account for the specific diameter, taper angle, and focal distance requirements of each object type. In such an embodiment, the computer may be configured to automatically adjust the height of the lift mechanism 100 to the desired height or preset height based on the data from the distance sensor or the rotary encoder through the actuation of a motor.

By using a computer system to control the telescoping lift mechanism, the user of the apparatus may make precise micro adjustments to the position of the rack gears and their load. The instant invention coupled with a computer system may provide the user with an accurate and automated lifting mechanism. As a nonlimiting example, the user may input the desired lift height of the lift mechanism 100 into the computing device, wherein said input is electronically translated to a motor, resulting in mechanical actuation of the wheel 102 and/or movement of the first and second rack gears 114, 115 through data acquired from the distance sensor and/or the rotary encoder. For example, the user may input into the computer twenty-five (25) centimeters, and the computer will then extend or retract the load until the load is measured to be at twenty-five (25) centimeters. In another embodiment, if the lift mechanism has a range of fifty (50) centimeters, the user could input a distance of 50%, and the computer will then extend or retract the load until the load is measured to be at twenty-five (25) centimeters, or halfway to fifty (50) centimeters.

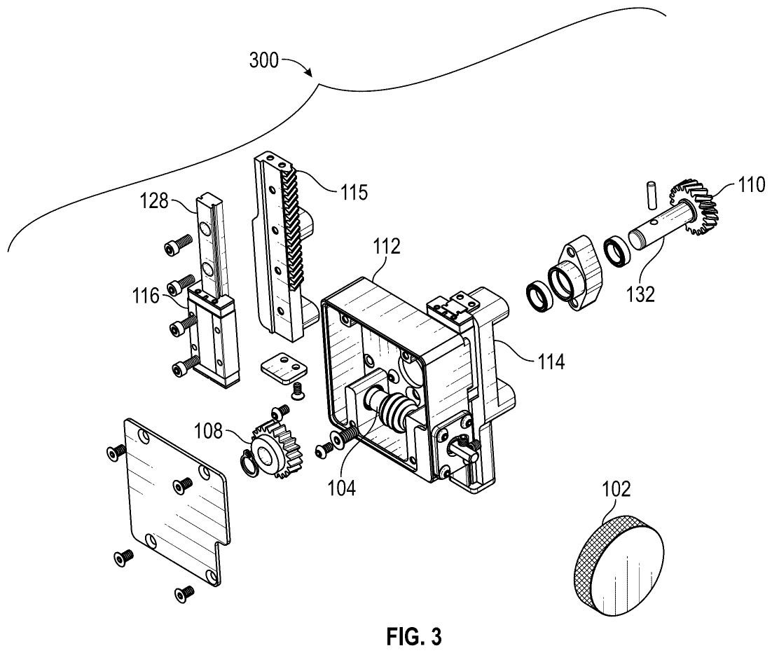

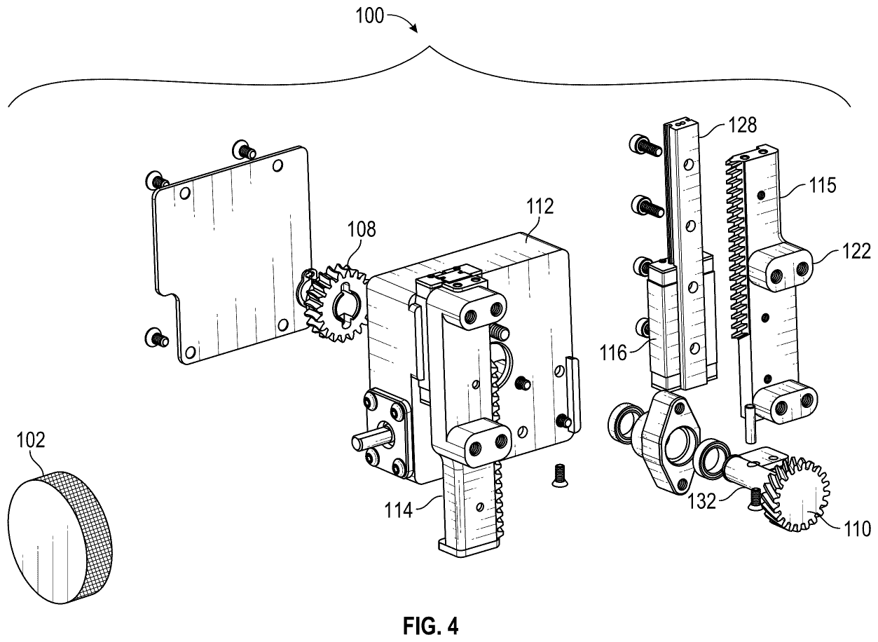

FIG. 3 and FIG. 4 show exploded views of the lift mechanism 100 from a top, right-side isometric front view and a top, left-side isometric rear view respectively.

In some embodiments, a lift mechanism system may include a first lift mechanism 301 and a second lift mechanism 302, where each may be integrated with a laser engraving apparatus 300, as illustrated in FIG. 5. In one or more embodiments, the laser engraving apparatus 300 may include a first portion 310 and a second portion 320. The first portion 310 may include a first object support device. The first object support device may be mounted on a first lift mechanism 301 configured to raise and/or lower the first object support device. The second portion 320 may include a second object support device such as the chuck housing 303. The second object support device may be mounted on a second lift mechanism 302 configured to raise and/or lower the second object support device. A first lift mechanism 301 may be used to adjust the height or other positioning of the object support device and a second lift mechanism 302 may be used to adjust the height or other positioning of the second object support device. The lift mechanisms 301, 302, which may be similar in structure and function to the previously described lift mechanism 100, may be mounted to the laser engraving apparatus 300 to provide controlled vertical or horizontal adjustment. In another embodiment, the laser head of a laser etching device may also be mounted on a similar lift mechanism in order to control the positioning of the laser head.

The lift mechanisms 301, 302 may be attached to a horizontal mounting rail 307 of the laser engraving apparatus 300. In some implementations, the horizontal mounting rail 307 may serve as a guide for the movement of either or both lift mechanism 301 and lift mechanism 302 and other components of the laser engraving system. The lift mechanisms 301, 302 may include components such as the wheel 102, gearbox 112, and first and second rack gears 114, 115, which have been previously described.

In some cases, the lift mechanism 301 may be used as a rear wheel support in the laser engraving apparatus 300. This configuration may allow for precise adjustment of the height or position of the first portion 310 of the laser engraving system. The lift mechanism 301 may be attached to a carriage or linear guide block of the laser gantry, enabling controlled movement along the horizontal mounting rail 307.

The laser engraving apparatus 300 may include a chuck housing 303 connected to a mounting bracket. The mounting bracket may be designed to accommodate an interchangeable chuck 305 and motor 306. This arrangement may allow for versatility in the types of objects that can be held and engraved by the laser engraving apparatus 300. The lift mechanism 302 may be used to adjust the position of the chuck housing 303 and interchangeable chuck 305 relative to other components of the laser engraving system.

In other embodiments, the lift mechanism system may include a third lift mechanism. The first or fixed rack gear of the third lift mechanism may be mounted onto a surface of the laser engraving apparatus. The second or movable rack gear of the third lift mechanism may be mounted to a laser head or other laser etching device. As the third lift mechanism transitions between extended and retraced states, the position of the laser head or other laser etching device may be adjusted.

In some implementations, the laser engraving apparatus 300 may incorporate a motor 306. The motor 306 may be connected to the lift mechanism 302 to provide automated control of the lifting and lowering operations. This configuration may allow for precise, motorized adjustments of the position of components supported by the lift mechanism 302.

The laser engraving apparatus 300 may also include a back roller 310 positioned along the horizontal mounting rail 307. The back roller 310 may work in conjunction with the lift mechanism 302 to provide stable and smooth movement of the supported components along the horizontal mounting rail 307. The at least one back roller 110 may be configured to prevent the article from moving backwards during laser engraving. In a nonlimiting example, the support provided by the at least one back roller 110 may steady an article, thus preventing the article from moving backwards while it is being engraved by a laser.

In some cases, the integration of the lift mechanism 302 with the laser engraving apparatus 300 may enhance the functionality of the laser engraving system in several ways. For example, the precise height adjustment provided by the lift mechanism 302 may allow for accurate positioning of the engraving surface relative to the laser. This may be particularly useful when working with materials of varying thicknesses or when fine-tuning the focus of the laser beam.

The self-locking feature of the lift mechanism 302, which may be achieved through the interaction of the worm screw 104 and worm gear 108 as previously described, may provide stability during the engraving process. This stability may be beneficial in maintaining consistent engraving quality, especially when working with heavier materials or during extended engraving operations.

In some implementations, the compact design of the lift mechanism 302 when in its retracted position may allow for efficient use of space within the laser engraving apparatus 300. This may be particularly advantageous in situations where the laser engraving system needs to operate in space-constrained environments or when the system needs to be transported or stored.

The integration of the lift mechanism 302 with the laser engraving apparatus 300 may also provide flexibility in terms of the types of objects that can be engraved. By allowing for precise vertical adjustments, the system may accommodate objects of varying heights and shapes, potentially expanding the range of applications for the laser engraving apparatus 300.

In some cases, the lift mechanism 100 may operate through a coordinated interaction of its various components to provide controlled linear motion and self-locking capabilities. The operation of the lift mechanism 100 may begin with the rotation of the wheel 102, as shown in FIG. 1A and FIG. 1B. The wheel 102 may be directly connected to the worm screw 104, causing the worm screw 104 to rotate when the wheel 102 is turned.

As the worm screw 104 rotates, the worm screw teeth 120 may engage with the worm gear teeth 130 of the worm gear 108. This engagement may convert the rotational motion of the worm screw 104 into rotational motion of the worm gear 108 about a different axis. The worm gear 108 may be mounted on the pinion gear shaft 132, which may extend through the gearbox 112, as illustrated in FIG. 1B.

The pinion gear 110, which may be connected to the pinion gear shaft 132, may rotate along with the worm gear 108. As shown in FIG. 1C, the pinion gear teeth 126 of the pinion gear 110 may mesh with the rack teeth 118 of the first and second rack gears 114, 115. This interaction may convert the rotational motion of the pinion gear 110 into linear motion of the first and second rack gears 114, 115.

In some cases, the first and second rack gears 114, 115 may be supported by one or more bearing blocks 116, as depicted in FIG. 1A and FIG. 1B. The bearing blocks 116 may allow the rack gear 114 to move smoothly along the guide rail 128, ensuring precise and controlled linear motion.

The self-locking feature of the lift mechanism 100 may be achieved through the interaction between the worm screw 104 and the worm gear 108. The angle of the worm screw teeth 120 may be designed such that when no rotational force is applied to the wheel 102, the load on the second rack gear 115 cannot cause the worm gear 108 to rotate backwards. This may effectively lock the position of the first and second rack gears 114, 115 without the need for additional locking mechanisms. This self-locking feature may be accomplished through sufficient static and/or dynamic friction between the worm gear teeth 130 and the worm screw teeth 120.

In some implementations, the lift mechanism 100 may be oriented vertically or horizontally, depending on the specific application requirements. When oriented vertically, the lift mechanism 100 may provide vertical lifting or lowering of a load attached to the second rack gear 115. In a horizontal orientation, the lift mechanism 100 may facilitate lateral movement of a load.

For example, in a vertical orientation, rotating the wheel 102 clockwise may cause the second rack gear 115 to extend upwards, lifting a load. Conversely, rotating the wheel 102 counterclockwise may retract the second rack gear 115, lowering the load. In a horizontal orientation, clockwise rotation of the wheel 102 may extend the second rack gear 115 horizontally, while counterclockwise rotation may retract the second rack gear 115.

The precision control of the lift mechanism 100 may be achieved through the gear ratios between the worm screw 104, worm gear 108, and pinion gear 110. These gear ratios may allow for fine adjustments of the second rack gear 115 position with relatively large rotations of the wheel 102. For instance, multiple rotations of the wheel 102 may result in a small linear movement of the second rack gear 115, enabling precise positioning of the attached load.

In some cases, as illustrated in FIG. 3, the lift mechanism 302 may be integrated into a laser engraving apparatus 300. The lift mechanism 302 may be mounted on the horizontal mounting rail 307, allowing for precise adjustment of components such as the chuck housing 303 and interchangeable chuck 305. The self-locking feature of the lift mechanism 302 may help maintain the position of these components during the engraving process, even when subjected to forces from the operation of the laser engraving apparatus 300.

The compact design of the lift mechanism 100, particularly when in its retracted position, may allow for efficient use of space in various applications. For instance, in the laser engraving apparatus 300 shown in FIG. 3, the lift mechanism 302 may provide necessary adjustment capabilities without significantly increasing the overall footprint of the system.

In some implementations, the lift mechanism 100 may be operated manually using the wheel 102, or automatically using a motor 306, as shown in FIG. 3. When operated by a motor 306, the lift mechanism 100 may provide automated, precise control of the first and second rack gears 114, 115 position, potentially enhancing the efficiency and repeatability of operations in applications such as the laser engraving apparatus 300.

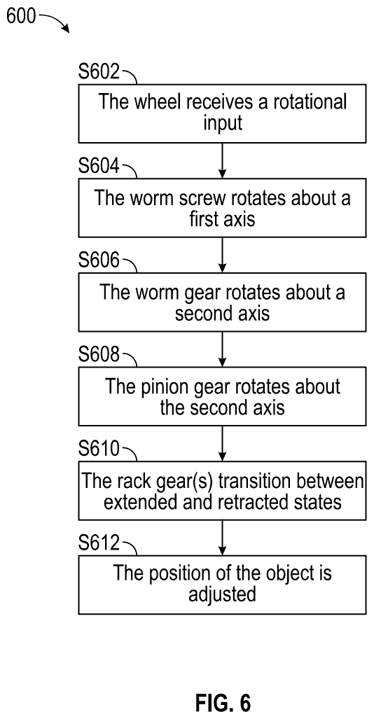

FIG. 6 illustrates an exemplary method in accordance with one or more embodiments of the present disclosure. At S602, the wheel may receive a rotational input causing the wheel to rotate about a first axis.

At S604, the rotation of the wheel may cause the worm screw to rotate about the first axis.

At S606, the meshing of the worm screw teeth with the worm gear teeth may cause the worm ger to rotate about a second axis.

At S608, the rotation of the worm gear may cause the pinion gear to rotate about the second axis.

At S610, the meshing of the pinion gear teeth with the rack teeth may cause the first rack gear and/or second rack gear experience linear motion and transition between extended and retracted states.

At S612, as the rack gears transition between the extended and retracted states, the position of the object may be adjusted.

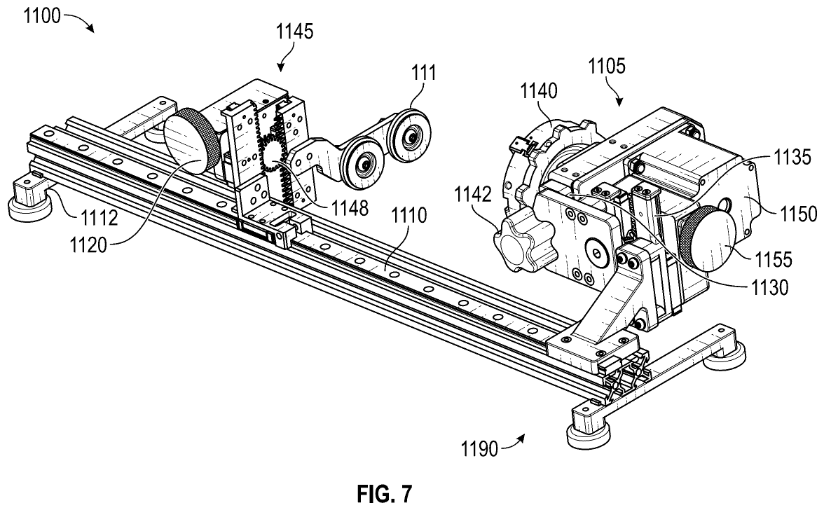

FIG. 7 is a perspective view from the left side of the alternate embodiment of the apparatus when viewing from the motor end of the apparatus. The apparatus 1110 may comprise a motor 1150 that drives the chuck gear box 1130. The chuck gear box 1130 may rotate the chuck 1140. The chuck assembly 1115 may be raised and lowered using the chuck assembly vertical lift adjustment drive 1135. The chuck assembly 1115 may be mounted to the rail 1110 and base 1112. The chuck assembly 1115 may be affixed to the rail 1110 and base 1112.

The instant invention provides a number of features that increases the usability of the device for engraving. The rail 1110 may use a Thomson linear bearing and rail to provide better precision. The belt drive system may provide better control due to decrease in tolerance stack up with respect to a gear or reciprocating ball drive. The tilt system may allow the chuck 1140 to rotate to align with the work piece being engraved. The vertical lift adjustment for the chuck assembly 1115 may allow the height of the chuck to be adjusted to accommodate a larger range of work piece. The back support 1145 vertical adjustment may provide further flexibility to accommodate a wider range of work pieces. The instant invention may provide additional rigidity by utilizing interlocking components to ensure the components lock together to limit motion and deflection in the chuck 1140.

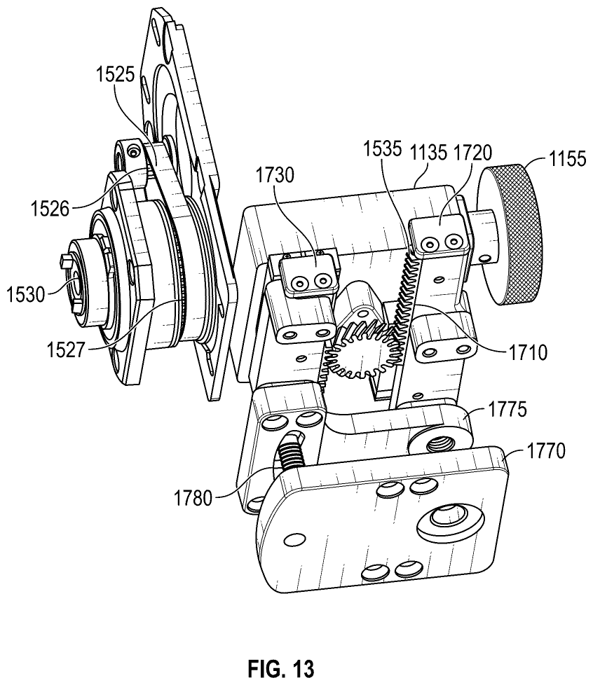

Furthermore, the tilt adjustment knob 1142 of the instant invention may provide tilt adjustment for the chuck 1140. The tilt adjustment knob 1142 may have markings for the desired angle adjustment. The tilt adjustment knob 1142 may be connected to a first plate 1770 and a second plate 1775 (shown in FIG. 13). The second plate 1775 may interface with the grip mount to allow the grip to tilt. The second plate 1775 may have a radial slot 1780 cut into the second plate 1775 configured to permit the chuck assembly 1115 to rotate. The rotation may center about a pin 1195 (shown in FIG. 7). The operator may adjust the tilt adjustment knob 1142 to cause the chuck 1140 to rotate according to the rotational change desired.

A vertical lift adjustment dial 1155 may enable the instant invention to engrave large items by increasing the clearance between the support tabletop 1190 (shown in FIG. 7) and the rail 1110. The user may adjust the height by twisting the vertical lift adjustment dial 1155, providing more clearance between the bottom portion of the item to be engraved, the support tabletop 1190, and the rail 1110.

The dual Thomson shaft rail may be replaced with a Thomson linear bearing and rail. Linear guides may consist of a linear rail and a carriage that moves along the rail. The rail may be mounted to the frame of the instant invention, and the rear support may ride on a carriage mounted to the rails to facilitate a smooth linear motion. As shown in FIG. 7, the linear guides and the linear rail are engineered to provide high accuracy, repeatability, and rigidity to provide increased precision and reduce error in the engraving process.

The back support 1145 may be moveable along the rail 1110 and may have a back support lift adjustment dial 1120. The back support lift adjustment dial 112 may be configured to operate the back support lift gear drive and racks 1148 and may be enabled to raise and lower the back support 1145. At least one back roller 111 may be attached to the back support 1145 and may support an object (e.g., a mug, glass, or thermos) that is to be laser engraved.

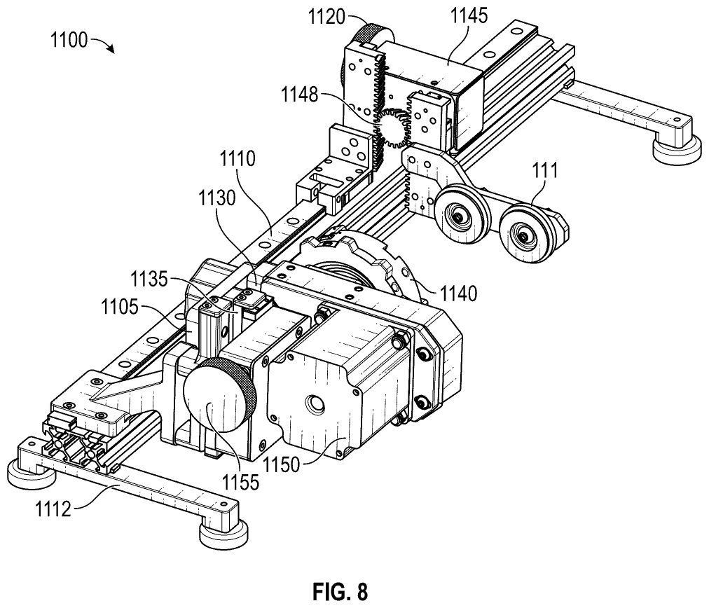

FIG. 8 is a perspective view from the right side of the alternate embodiment of the apparatus looking from the motor end of the apparatus. The apparatus 1110 may comprise a chuck assembly 1115, further comprising a motor 1150 and a chuck assembly vertical lift adjustment drive 1135 enabled to raise and lower chuck assembly 1115. The chuck assembly 1115 may be mounted to the rail 1110 and base 1112. The chuck assembly 1115 may be affixed to the rail 1110 and base 1112.

The back support 1145 may be moveable along the rail 1110 and may have a back support lift adjustment dial 1120 configured to operate the back support lift gear drive and racks 1148 to raise and lower the back support 1145. At least one back roller 111 may be attached to the back support 1145. At least one back roller 111 may support an object (e.g., a mug, glass, or thermos) (not shown) that is to be laser engraved.

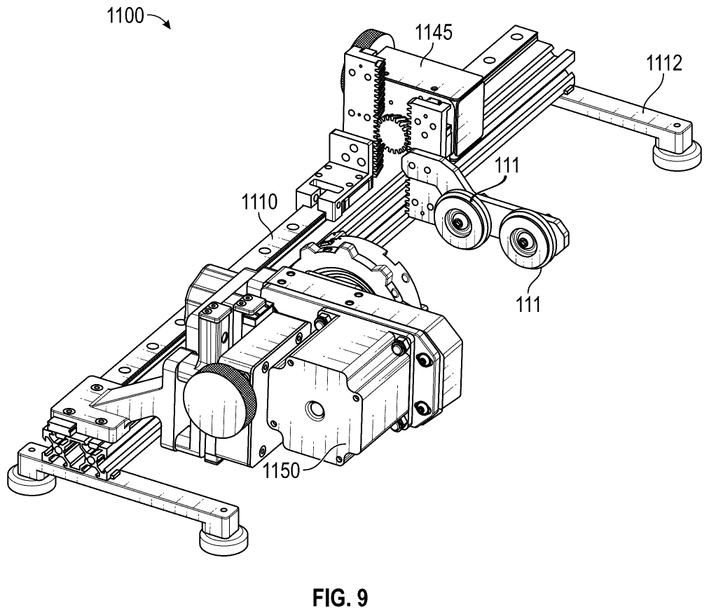

FIG. 9 is a close-up perspective view from the left side of the alternate embodiment of the apparatus looking from the motor end of the apparatus. The apparatus 1110 may have a motor 1150 affixed to the rail 1110, and a base 1112 connected to the back support 1145.

The back support 1145 may be moveable along the rail 1110 and may have at least one back roller 111 to support the work piece (not shown) that is to be laser engraved.

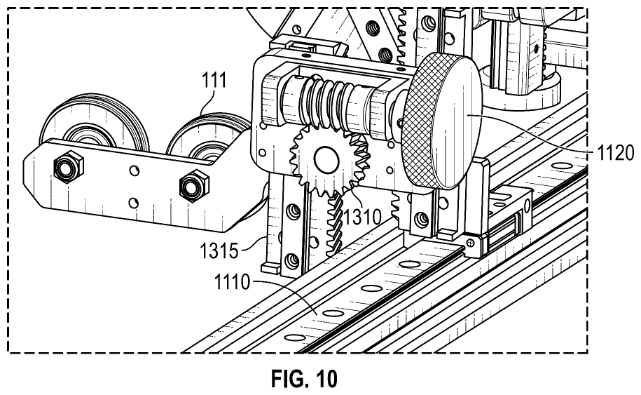

FIG. 10 is a close-up perspective view of the back support adjustment. The back support lift gear drive and racks 1148 shown in FIG. 7 may be controlled using the back support lift adjustment dial 1120 configured to move the back support lift adjustment drive gear 1310 and back support lift adjustment associated racks 1315. The back support lift adjustment associated racks 1315 may vertically adjust the height of at least one back roller 111.

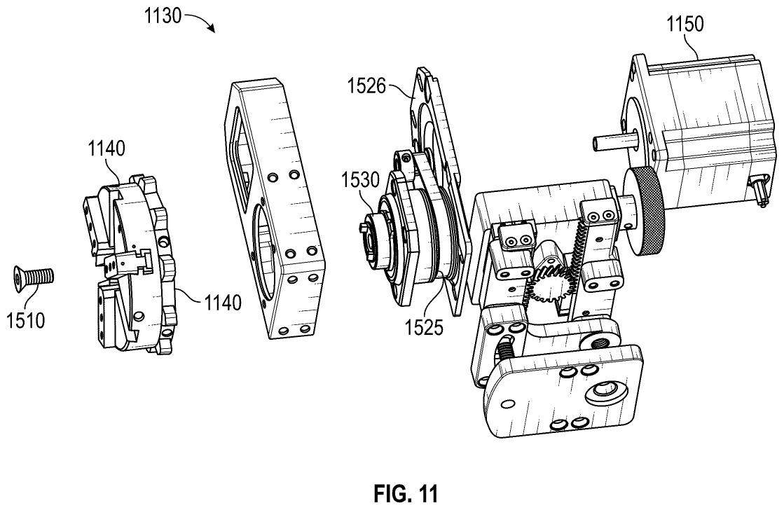

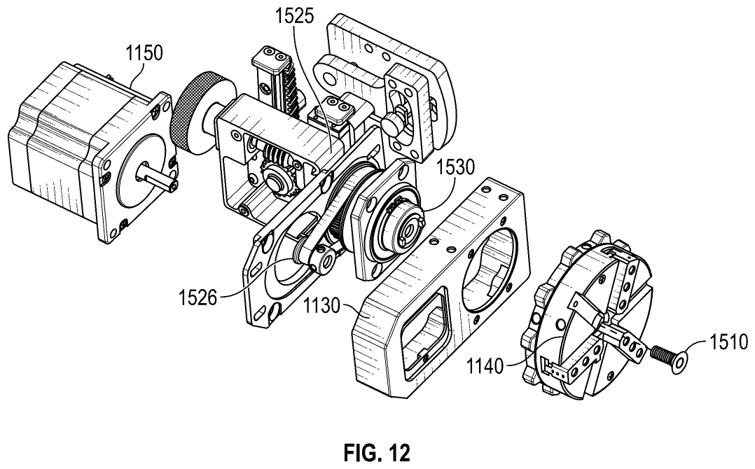

FIG. 11 is a top perspective exploded view from the left side of the chuck viewed from the motor end of the apparatus. The motor 1150 may be connected to the chuck drive belt 1525 using a gear 1526 housed in a chuck gear box 1130. The chuck drive belt 1525 may drive a spindle 1530 using a spindle drive gear 1527. A spindle 1530 may be affixed to the chuck 1140 with a chuck center screw 1510. The chuck center screw 1510 may allow the chuck grip to easily fasten to the chuck assembly 1115, while maintaining a tight grip to the spindle 1530. As seen in FIG. 12, the chuck gear box 1130, the spindle 1530, and the inward facing surface of the grip, all lock together. The spindle 1530, the gear box 1130 configured to accept the spindle 1530, and the inward face of the grip 1141, may all have complementary geometry to allow them to lock together securely while being held by the chuck center screw 1510.

As shown in FIGS. 11 and 13, the chuck gear box 1130 may be attached to the chuck assembly vertical lift adjustment mechanism 1535. The chuck assembly vertical lift adjustment drive 1135 may have a chuck assembly vertical lift adjustment mechanism 1535 that is based on parallel adjustment devices used in specialty equipment or rack and pinion configurations where accurate positioning in linear motion is required. The chuck assembly vertical lift adjustment mechanism 1535 may comprise a pinion 1710, a stationary rack 1720, a moveable rack 1730, and a chuck assembly vertical lift adjustment dial 1155.

FIG. 12 is a top perspective exploded view from the right side of the chuck viewed from the motor end of the apparatus. The motor 1150 may be connected to the chuck drive belt 1525 via gear 1526 housed in the chuck gear box 1130. The chuck drive belt 1525 may drive the spindle 1530. The spindle 1530 may be attached to the chuck 1140 with a chuck center screw 1510. The use of a belt drive may provide better rotation control than a typical gear drive transmission for laser engraving relative to the RPM of the motor due to the elimination of the machining tolerances of a gear drive. A drive belt may also allow the startup torque to be reduced because the belt provides compliance that allows the motor to initiate rotation without coming up against the load to be moved, due to the compliance of the belt and pulley design.

The attachment apparatus for laser engraving an object of the instant invention in most applications may be attached to a computer system to drive the motor 1150 and the adjustment devices such as the lift, the back support lift adjustment dial 1120, and the chuck assembly vertical lift adjustment drive 1135. The computer system may be one computer or a plurality of computers, and the computer system may also be a stand-alone device or a networked device. The computer system may have a program to control the attachment apparatus of the instant invention for laser engraving an object so as to engrave the work piece.

The invention of the present disclosure may include a telescoping self-locking lift mechanism configured to allow for fine adjustment without obstructing a laser gantry. For example, the telescoping self-locking lift mechanism may not protrude from the grip in a manner to create obstructions with the laser gantry or other objects.

Yet further, the invention of the present disclosure may include a tilt adjustment configured for one-handed actuation.

The invention of the present disclosure may include a geared (i.e., belted) motor-to-grip coupling. Such a geared motor-to-grip coupling may provide for higher torque, higher movement resolution, and an increased ability to engrave heavy objects.

The invention of the present disclosure may include a removable grip plate, for example, held in place by a single screw. Such a removable grip plate may provide an advantage over grips that are not removable or otherwise require extensive manipulation to remove. As a nonlimiting example, a user may own an assortment of grip plates hosting different grip configurations, wherein the removable grip plate aspect allows the user to quickly and efficiently swap such configurations.

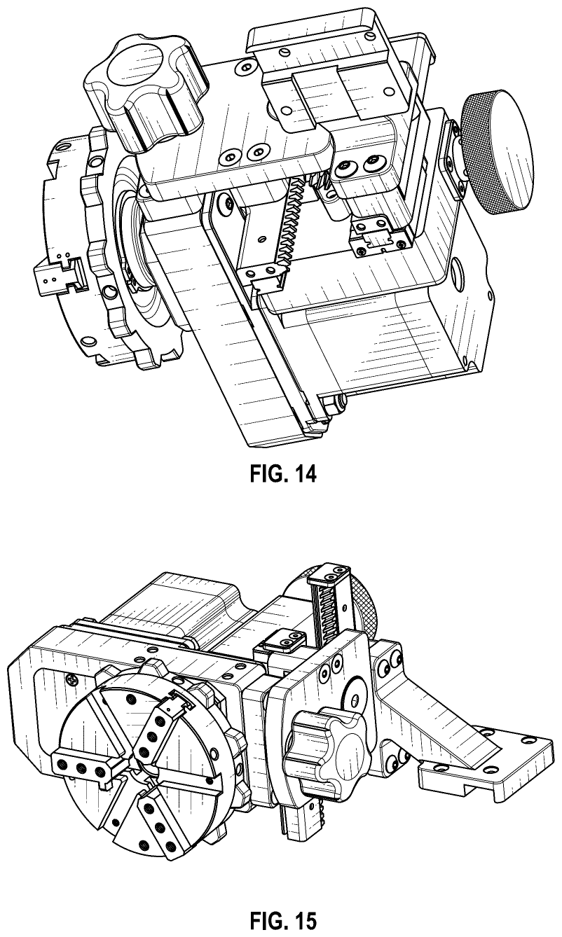

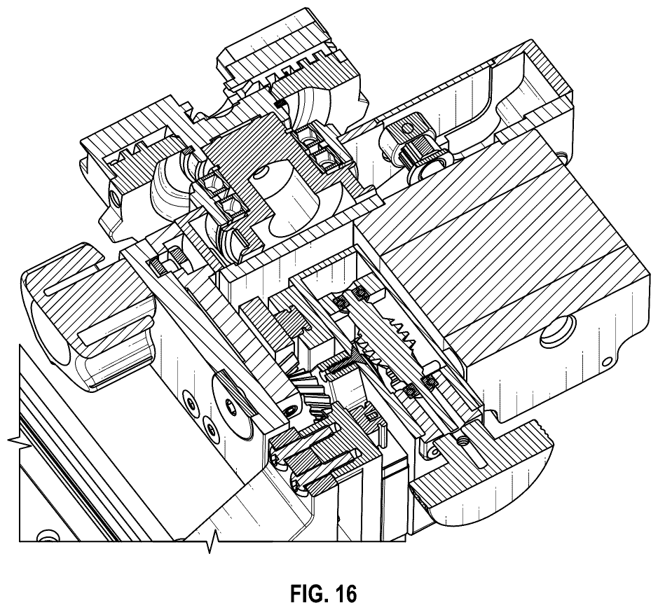

The aforementioned improved grip assembly and components thereof are at least visible in FIGS. 7-16 of the attached drawings. FIG. 14 shows a bottom view of the chuck assembly. FIG. 15 shows a front view of the chuck assembly. FIG. 16 shows a sectional view of the chuck assembly.

In some embodiments, the method or methods described above may be executed or carried out by a computing system including a tangible computer-readable storage medium, described herein as a storage machine, that holds machine-readable instructions executable by a logic machine (i.e. a processor or programmable control device) to provide, implement, perform, and/or enact the foregoing methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not limiting. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments. It should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public, and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

A number of implementations have been described. Nevertheless, it will be understood that various modifications may be made without departing from the spirit and scope of the disclosure. Accordingly, other implementations are within the scope of the following claims.

1. A laser engraving apparatus comprising:
an object; and
a lift mechanism configured to provide a telescoping lift to the object, the lift mechanism comprising:
a wheel configured to receive a rotational input causing the wheel to rotate about a first axis;
a worm screw comprising a worm shaft coupled to a wheel shaft of the wheel, wherein the worm screw rotates about the first axis with the wheel;
a worm gear configured to mesh with the worm screw, the worm gear comprising a pinion slot, and wherein the worm gear is configured to rotate about a second axis;
a pinion gear comprising a pinion shaft configured to insert into the pinion slot, wherein the pinion gear rotates with the worm gear about the second axis in a first direction and a second direction;
a rack gear system configured to mesh with the pinion gear, the rack gear system comprising:
a first rack gear mountable to the laser engraving apparatus; and
a second rack gear mountable to the object;
wherein the rack gear system transitions between an extended state and a retracted state, and wherein a vertical position of the object is adjusted by the rack gear system transitioning between the extended state and the retracted state.

2. The laser engraving apparatus of claim 1, wherein the first rack gear is statically coupled to a mounting surface of the laser engraving apparatus, and wherein the second rack gear is coupled to object manipulation device configured to manipulate the object.

3. The laser engraving apparatus of claim 1, wherein a gear reduction ratio between the worm screw and the worm gear is sufficiently high to prevent movement of the pinion gear without the rotational input of the wheel.

4. The laser engraving apparatus of claim 3, wherein the gear reduction ratio is between 10:1 and 50:1.

5. The laser engraving apparatus of claim 1, wherein the lift mechanism further comprises a gearbox housing the worm screw and the worm gear.

6. The laser engraving apparatus of claim 5, wherein the lift mechanism further comprises:
a first bearing block coupled to a gearbox exterior, the first bearing block configured to guide the gearbox along the first rack gear in a first linear path; and
a second bearing block coupled to the gearbox exterior, the second bearing block configured to guide the second rack gear along a second path relative to the gearbox.

7. The laser engraving apparatus of claim 1, wherein the worm screw further comprises a helix configured to mesh with a set of worm gear teeth of the worm gear.

8. The laser engraving apparatus of claim 7, wherein the helix comprises a helix angle providing for a gear reduction ratio sufficient to prevent a load force being applied to the worm screw through the worm gear from causing the worm screw to rotate.

9. The laser engraving apparatus of claim 1, wherein the lift mechanism further comprises:
a motor configured to engage the wheel; and
a processor configured to receive an input, wherein the processor engages the motor to rotate the wheel based on the received input.

10. The laser engraving apparatus of claim 1, wherein the lift mechanism further comprises a sensor configured to measure change in distance of the load.

11. A lift mechanism for adjusting the height of an object to be engraved with a laser engraving apparatus, the lift mechanism comprising:
a wheel configured to receive a rotational input causing the wheel to rotate about a first axis;
a worm screw having a worm shaft coupled to a wheel shaft of the wheel, wherein the worm screw rotates about the first axis with the wheel;
a worm gear configured to mesh with the worm screw, the worm gear comprising a pinion slot, and wherein the worm gear is configured to rotate about a second axis;
a pinion gear comprising a pinion shaft configured to insert into the pinion slot, wherein the pinion gear rotates with the worm gear about the second axis in a first direction and a second direction;
a fixed rack gear and a moveable rack gear configured to mesh with the pinion gear, wherein the fixed rack gear and the moveable rack gear move between an extended state and a retracted state.

12. The lift mechanism of claim 11, wherein the fixed rack gear is statically coupled to a mounting surface of the laser engraving apparatus, and wherein the movable rack gear is coupled to the object.

13. The lift mechanism of claim 11, wherein a gear reduction ratio between the worm screw and the worm gear is sufficiently high to prevent movement of the pinion gear without the rotational input of the wheel.

14. The lift mechanism of claim 11, further comprising:
a motor configured to engage the wheel; and
a processor configured to receive an input, wherein the processor engages the motor to rotate the wheel based on the received input.

15. A lift mechanism system for adjusting the height of an object to be engraved with a laser engraving apparatus, the lift mechanism system comprising:
a first lift mechanism mounted to a first portion of the laser engraving apparatus; and
a second lift mechanism mounted to a second portion of the laser engraving apparatus;
wherein each the first lift mechanism and the second lift mechanism comprise:
a wheel configured to receive a rotational input causing the wheel to rotate about a first axis;
a worm screw having a worm shaft coupled to a wheel shaft of the wheel, wherein the worm screw rotates about the first axis with the wheel;
a worm gear configured to mesh with the worm screw, the worm gear comprising a pinion slot, and wherein the worm gear is configured to rotate about a second axis;
a pinion gear comprising a pinion shaft configured to insert into the pinion slot, wherein the pinion gear rotates with the worm gear about the second axis in a first direction and a second direction;
a fixed rack gear and a moveable rack gear configured to mesh with the pinion gear, wherein the fixed rack gear and the moveable rack gear move between an extended state and a retracted state, wherein the fixed rack gear is coupled to a mounting surface of the laser engraving apparatus, wherein the moveable rack gear of the first lift mechanism is coupled to a first end of the object, and wherein the moveable rack gear of the second lift mechanism is coupled to a second end of the object.

16. The lift mechanism system of claim 15, wherein the laser engraving apparatus further comprises a horizontal rail.

17. The lift mechanism system of claim 16, wherein the first lift mechanism is slidably coupled to the horizontal rail.

18. The lift mechanism system of claim 16, wherein each of the first lift mechanism and the second lift mechanism are slidably coupled to the horizontal rail.

19. The lift mechanism system of claim 15, wherein the first lift mechanism and the second lift mechanism are configured to be adjusted simultaneously.

20. The lift mechanism system of claim 15, further comprising a third lift mechanism coupled to a laser etching device, the laser etching device configured to engrave the object.
